(19) United States
(12) Patent Application Publication
(10) Pub. No.: US 2009/0181294 A1
(43) Pub. Date: Jul. 16, 2009

(54) Battery Separators and Batteries

(76) Inventor: Robert Yoppolo, New Milford, CT (US)

Correspondence Address: FISH & RICHARDSON P.C., P.O. BOX 1022, MINNEAPOLIS, MN, 55440-1022, US

(21) Appl. No.: 11/972,996

(22) Filed: Jan. 11, 2008

(51) Int. Cl. H01M 2/18

(52) U.S. Cl. 429/142; 29/623.1

(57) ABSTRACT

Batteries are provided that include a tubular battery separator having a locally strengthened region. The strengthened region maybe provided by including a folded area adjacent an open end of the tubular separator.

### TECHNICAL FIELD

This invention relates to battery separators and batteries.

### BACKGROUND

Batteries, or electrochemical cells, such as primary alkaline batteries or secondary lithium batteries, are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material. In order to prevent direct reaction of the anode material and the cathode material, the anode and the cathode are electrically isolated from each other by a separator.

When a battery is used as an electrical energy source in a device, electrical contact is made between the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

In recent times, there as been an increasing interest in utilizing thinner and thinner separator materials in alkaline batteries. Tubular designs are generally the most volume efficient and offer the potential for the highest discharge efficiency. It is desirable to minimize the amount of separator material in the cell, and thus it would be ideal to have a tube that includes only a single wrap of the separator material with a small overlap for a seam. However, due to processing limitations if a thin, light separator paper is used (e.g., having a basis weight of less than about 40 g/m² and a wet thickness of less than about 0.2 mm) it is generally more realistic to wrap the tube 1.25 to 2.25 wraps to ensure anode does not leak through the seam and to provide added protection from shorting through the material. The thin-walled tube also tends to be weak, and thus anode material may escape from the open end of the sealed anode cavity.

### SUMMARY

The present disclosure features tubular separators having a localized strengthened area at an end of the tube. In some implementations, this strengthened area is formed by folding over the separator material, and is positioned at the open end of the tube. This strengthened area stiffens the open end of the tube to provide added protection from collapsing and distortion, and thus against anode material escaping when the cell is dropped or otherwise abused. By localizing the stiffened area to the weak open end of the cell, discharge efficiency is maximized by maintaining a single layer of separator material along the majority of the cathode column. Utilizing a folded separator sheet to form the tubes lends itself well to continuous motion high speed manufacturing. By locally strengthening the end of the tube, very thin separator papers may be used while still minimizing wraps. For example, the separator paper may have a thickness of less than 0.2 mm wet thickness and 0.09 mm dry thickness, or in some cases less than 0.1 mm wet thickness and 0.06 mm dry thickness with a 1.25 to 2.25 wrap construction.

In one aspect, the invention features an electrochemical cell comprising a generally cylindrical housing, and, within the housing, a cathode, an anode, and a separator disposed between the cathode and anode. The separator is in the form of a tube having an open end, and the separator includes a locally strengthened region adjacent the open end.

Some implementations may include one or more of the following features. The locally strengthened region comprises a folded portion of the separator. The separator comprises paper. The separator has a wet thickness of less than about 0.15 mm. The folded portion has a width of about 3 to 12 mm, measured along a longitudinal axis of the cell. The tube is formed with less than two wraps, or even less than 1.5 wraps. The cell comprises an alkaline cell.

In another aspect, the invention features a battery separator comprising a paper sheet material having a wet thickness of less than about 0.30 mm, formed into a tube. The tube has an open end, and the separator includes a locally strengthened region adjacent the open end.

Some implementations include one or more of the following features. The locally strengthened region comprises a folded portion of the separator. The paper has a wet thickness of less than about 0.15 mm. The folded portion has a width of about 3 to 12 mm, measured along a longitudinal axis of the tube. The tube is formed with less than two wraps, or even with less than 1.5 wraps.

The invention also features methods of forming electrochemical cells. One such method comprises locally strengthening an edge region of a sheet material; forming the sheet material into a hollow tube having an open end, with the locally strengthened edge positioned at the open end of the tube; and positioning the tube in a battery can between a cathode material and an anode material.

Some implementations may include one or more of the following features. The cathode material defines a chamber into which the tube is inserted, and the method further comprises inserting the anode material into the open end of the tube. Locally strengthening comprises forming a folded over portion at the edge region. Forming the sheet material into a tube comprises forming less than two wraps of the sheet material around a mandrel. Forming the sheet material into a tube further comprises forming a closed end opposite the open end. Folding comprises forming a folded portion having a width of about 3 to 12 mm, measured along a longitudinal axis of the tube.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of a folded separator sheet. FIG. 1A is an enlarged perspective view of the folded area of the sheet shown in FIG. 1.

FIG. 2 is a perspective view of a tubular separator formed using a folded separator sheet as shown in FIG. 1, sectioned to show the overlapping folded areas.

FIG. 3 is a perspective view of a tubular separator using a folded separator sheet and 1.5 wraps.

FIG. 4 is a perspective view of a tubular separator using a folded separator sheet and less than 1.25 wraps.

Like reference symbols in the various drawings indicate like elements.

### DETAILED DESCRIPTION

In preferred implementations, a folded separator sheet is used to form a tubular separator that is then utilized between the cathode and anode in a cylindrical cell. The folded area is positioned at the open end of the tube to stiffen the vulnerable open end. The separator may be formed of any flexible sheet material suitable for use as a separator in an electrochemical cell, for instance paper. Preferably, the separator material is thin. For example, for an AA battery, the separator may have a wet thickness of less than 0.30 mm, preferably less than 0.20 mm and more preferably less than 0.10 mm, and a dry thickness of less than 0.10 mm, preferably less than 0.07 mm and more preferably less than 0.06 mm. The basis weight of the paper is generally in the range of about 20 to 80 g/m². In some preferred implementations the paper has a basis weight of 35 g/m² or less.

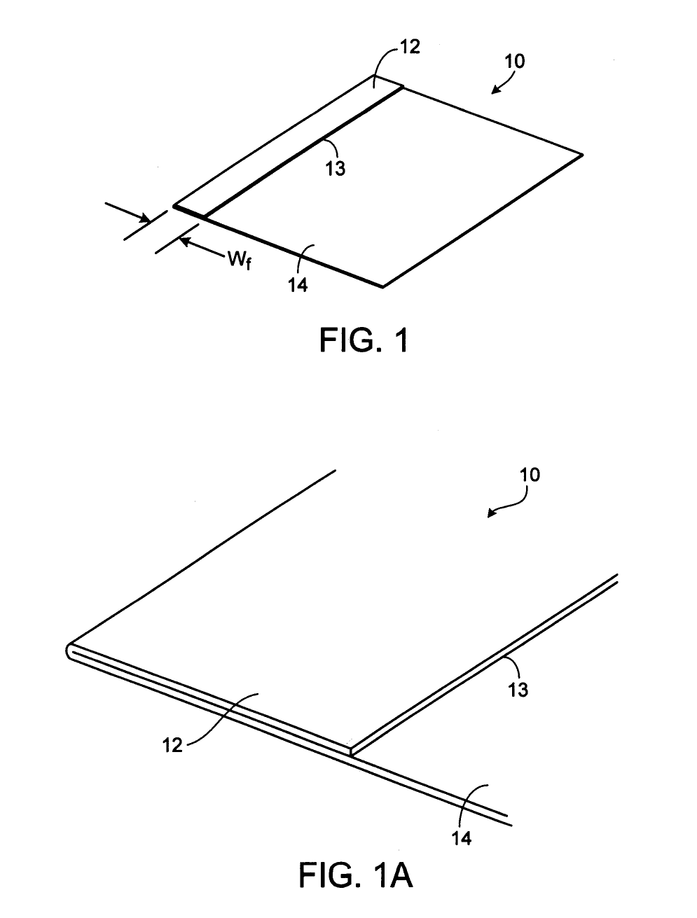

Referring to FIGS. 1 and 1A, a separator sheet 10 is shown having a folded region 12 and an unfolded, single layer region 14. The folded region 12 may be formed, for example, by folding the separator sheet 180 degrees against itself at the edge 13 of the sheet that will eventually form the open end of the tube. Folding may be accomplished using any desired technique, e.g., by guiding the paper from a reel through a track in which it is bent, e.g., using a wheel, and winding it up on a take-up reel. The separator sheet 10 may be in the form of a continuous web of material.

The width of the fold (W_{f}, FIG. 1) will depend on the degree of stiffening that is required, which will in turn depend on the stiffness of the separator material, cell size, and the stiffness required for a particular cell design. Typically, the width of the fold will be from about 3 to 12 mm, e.g., from about 3 to 6 mm, with the width of the fold generally increasing with increasing cell diameter if other factors (e.g., separator material) are held constant. For relatively small diameter cells, e.g., AAA and AA cells, the width of the fold is typically from about 5% to about 20% of the cell height, preferably about 7% to about 16%. For larger diameter cells, e.g., C and D cells, the width of the fold is typically from about 10% to about 25% of the cell height, preferably about 12% to about 20%. Typical cell heights and ranges for typical cathode inner diameters for these standard cell sizes are as follows:

| Cell Size | Cell Height (mm) | Cathode ID (mm) |
|---|---|---|
| AAA | 44.5 | 6.3-6.6 |
| AA | 50.5 | 8.8-9.2 |
| C | 50 | 16.2-16.6 |
| D | 61.5 | 21.2-21.6 |

The folded separator sheet is then fed into a tube winder, to form it into the separator tube. Preferably, the folded edge is positioned toward the inner diameter of the tube, so that the folded edge will not catch on the cathode column when it is inserted.

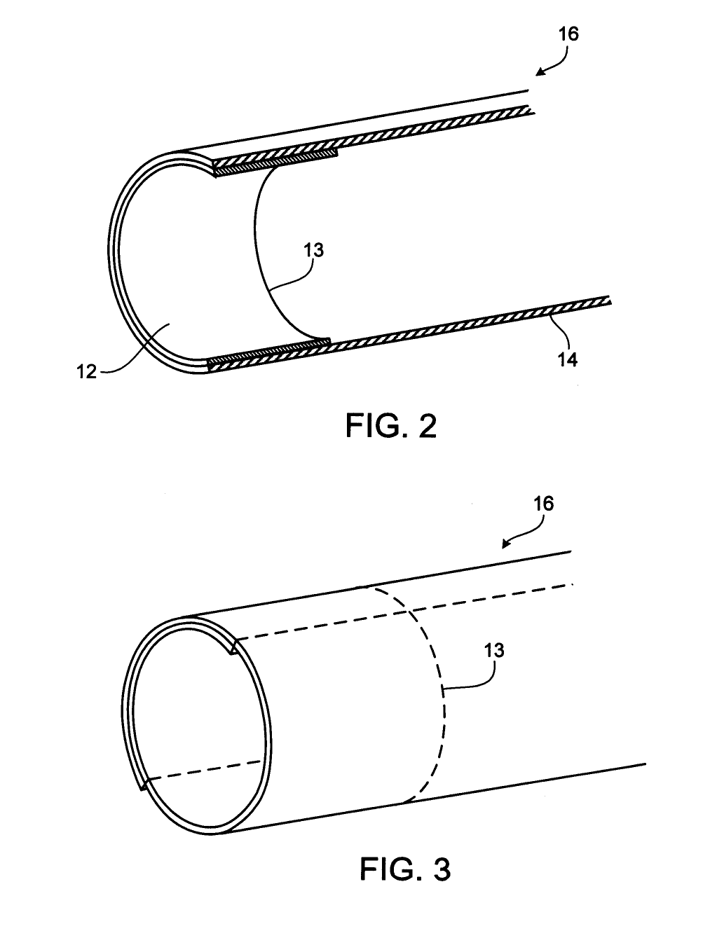

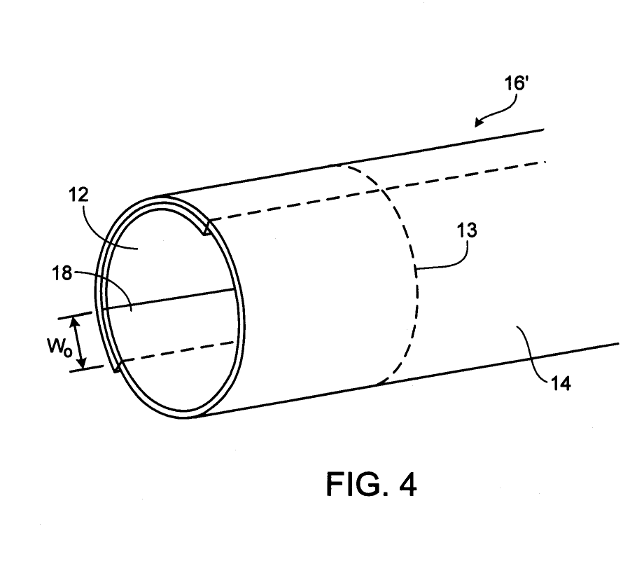

Completed separator tubes 16, 16′ are shown in FIGS. 2-4. In FIGS. 2-3, the separator tube 16 is formed by wrapping the separator sheet about 1.5 times, resulting in an overlapping area that extends about halfway around the circumference of the tube. In FIG. 4, the separator tube is wound one and a quarter wraps about a mandrel, creating a single-walled tube with only a small overlap 18 to form a seam. The width of the overlap (Wₒ) may be the minimum that is needed in order to form a sealed seam, e.g., by providing a heat-sealable separator paper and butt-welding the opposed edges. However, due to the cost of heat-sealable paper and other manufacturing constraints, generally more overlap is used (a quarter wrap or more) to allow the tube to be formed without welding, by folding over the end of the rolled tube to form a bottom and inserting the separator into a battery can while the rolled tube is still on the mandrel.

Alternatively, the separator tube can be manufactured using a process in which a separate disc or square of separator material forms the bottom of the tube. In this process, the body of the tube is wound on a mandrel, a separate disc or square is placed on top of the cathode column, and the wound tube on the mandrel is inserted into the open end of the column forcing the disc or square to the bottom and forming the disc or square around the circumference of the bottom of the tube.

In some implementations, the cell is formed by first inserting doughnut-shaped pellets of the cathode material into the can, then inserting the separator tube—open end up—into the cavity defined by the openings in the stacked pellets, and then inserting the anode material into the open end of the separator tube.

### OTHER EMBODIMENTS

A number of embodiments of the invention have been described. Nevertheless, it will be understood that various modifications may be made without departing from the spirit and scope of the invention.

For example, while certain dimensions are discussed above, the preferred dimensions will vary depending on the strength needed for a particular cell design, the thickness of the separator, the number of wraps, the battery size (e.g., cell height and diameter), the paper properties, and the capturing of the open tube end in the battery assembly.

Moreover, while folding the separator is generally the most cost-effective method of making a localized strengthened area, other methods may be utilized. For example, a reinforcing strip may be glued along the edge region (the folded over area), or a stiffening coating may be applied to the same area.

Additionally, if desired the edge could be folded multiple times, e.g., the folded portion could be folded over again on itself.

The cell may be a primary or secondary cell, and may be an alkaline cell or have any other desired cell chemistry. The features described herein are suitable for use in any type of bobbin-constructed cell.

Accordingly, other embodiments are within the scope of the following claims.

1. An electrochemical cell comprising:
a generally cylindrical housing, and,
within the housing, a cathode, an anode, and a separator disposed between the cathode and anode,
wherein the separator is in the form of a tube having an open end, and the separator includes a locally strengthened region adjacent the open end.

2. The electrochemical cell of claim 1 wherein the locally strengthened region comprises a folded portion of the separator.

3. The electrochemical cell of claim 2 wherein the separator comprises paper.

4. The electrochemical cell of claim 1 wherein the separator has a wet thickness of less than about 0.15 mm.

5. The electrochemical cell of claim 2 wherein the folded portion has a width of about 3 to 12 mm, measured along a longitudinal axis of the cell.

6. The electrochemical cell of claim 1 wherein the tube is formed with less than two wraps.

7. The electrochemical cell of claim 6 wherein the tube is formed with less than 1.5 wraps.

8. The electrochemical cell of claim 1 wherein the cell comprises an alkaline cell.

9. A battery separator comprising:
a paper sheet material having a wet thickness of less than about 0.30 mm, formed into a tube;
wherein the tube has an open end and the separator includes a locally strengthened region adjacent the open end.

10. The battery separator of claim 9 wherein the locally strengthened region comprises a folded portion of the separator.

11. The battery separator of claim 9 wherein the paper has a wet thickness of less than about 0.15 mm.

12. The battery separator of claim 10 wherein the folded portion has a width of about 3 to 12 mm, measured along a longitudinal axis of the tube.

13. The battery separator of claim 1 wherein the tube is formed with less than two wraps.

14. The battery separator of claim 6 wherein the tube is formed with less than 1.5 wraps.

15. A method of forming an electrochemical cell comprising:
locally strengthening an edge region of a sheet material;
forming the sheet material into a hollow tube having an open end, with the locally strengthened edge positioned at the open end of the tube; and
positioning the tube in a battery can between a cathode material and an anode material.

16. The method of claim 15 wherein the cathode material defines a chamber into which the tube is inserted, and the method further comprises inserting the anode material into the open end of the tube.

17. The method of claim 15 wherein locally strengthening comprises forming a folded over portion at the edge region.

18. The method of claim 15 wherein forming the sheet material into a tube comprises forming less than two wraps of the sheet material around a mandrel.

19. The method of claim 18 wherein forming the sheet material into a tube further comprises forming a closed end opposite the open end.

20. The method of claim 17 wherein folding comprises forming a folded portion having a width of about 3 to 12 mm, measured along a longitudinal axis of the tube.
